(19) United States
(12) Patent Application Publication
(10) Pub. No.: US 2002/0021323 A1
(43) Pub. Date: Feb. 21, 2002

(54) Inkjet printing apparatus

(76) Inventors: Masaharu Kanazawa, Suita-Shi (JP); Koji Yamamoto, Kawanishi-Shi (JP); Norihiro Agawa, Itami-Shi (JP)

Correspondence Address: SIDLEY AUSTIN BROWN & WOOD, 717 NORTH HARWOOD, SUITE 3400, DALLAS, TX, 75201, US

(21) Appl. No.: 09/911,286

(22) Filed: Jul. 23, 2001

(30) Foreign Application Priority Data
Jul. 25, 2000 (JP) 2000-223723

(51) Int. Cl. B41J 2/145; B41J 2/15

(52) U.S. Cl. 347/41

(57) ABSTRACT

Disclosed is an inkjet printer comprises: an ink jet head having a first array of a plurality of nozzles from which ink drops are discharged; a scanning unit for scanning said ink jet head in a first direction so that the ink drops are discharged within a predetermined extent with respect to the first direction; and a transporter for reciprocally transporting a recording medium in a second direction orthogonal to the first direction, said transporter comprising at least one member brought into contacting with a recording surface of the recording medium, said at least one member being provided at a position that is outside of the predetermined extent with respect to the first direction. Since the transporter is brought into contact with the recording surface of the recording medium only at the position outside of the predetermined extent, the recorded ink that have not been dry is prevented from contacting with the member of the transporter, e.g., a roller. Therefore, a low cost printer that is capable of high speed recording without image quality deterioration can be obtained.

### CROSS-REFERENCE TO RELATED APPLICATION

This application is based on Japanese Patent Application No. 2000-223723 filed in Japan on Jul. 25, 2000, the entire content of which is hereby incorporated by reference.

### BACKGROUND OF THE INVENTION

1. Field of the Invention

The present invention relates to an inkjet printer that performs printing by discharging ink toward a recording medium.

2. Description of the Related Art

Conventionally known inkjet printers form images by repeating the operation in which an inkjet head having multiple nozzles (hereinafter the ‘head’) is moved along the recording medium (hereinafter the ‘sheet’) in a direction perpendicular to the alignment of the nozzles, and the sheet is forwarded at a prescribed pitch in a direction parallel to the alignment of the nozzles. In order to perform high-speed printing using this construction, the number of nozzles may be increased, but because this entails an increase in size of the head to the same degree, the space required for the movement of the head also increases, which leads to an increase in the size of the apparatus.

In order to avoid this problem, a hypothetical inkjet printer shown in FIG. 11 is possible. This printer 2 has a head 4 and a platen (support member) 6 located a prescribed distance from the ink discharge surface (bottom surface) of the head 4. Upstream of the head 4 in terms of the direction in which the sheet 8 is conveyed is located a pair of paper supply rollers 10 by which to convey the sheet 8, which was conveyed from the paper supply tray not shown in the drawing, onto the platen 6. Further downstream of the head 4 in terms of the direction in which the sheet 8 is conveyed is located a pair of paper eject rollers 12 by which to eject the sheet 8 onto the paper eject tray not shown in the drawing. Here, the direction of sheet conveyance means the direction in which the sheet is supplied to the area that faces the head 4 or the direction in which the sheet is ejected from this area. The multiple nozzles 14 of the head 4 are aligned perpendicular to the path of conveyance of the sheet 8 (i.e., in the direction that is perpendicular to the sheet in FIG. 11(a) and the top-down direction in FIG. 11(b), such direction being hereinafter referred to as the ‘head forwarding direction’) at a prescribed pitch.

Using this construction, an image is formed by repeating the operation in which the head is first placed at a prescribed position, the sheet is moved in either scanning direction, which is perpendicular to the head forwarding direction, the head is forwarded by a prescribed pitch in the head forwarding direction, and the sheet is moved in the opposite scanning direction. In +this printer 2, the range of movement of the head 4 does not change even when the number of nozzles 14 is increased and the head 4 is elongated. However, because the ink is discharged onto the sheet 8 while the sheet 8 is moved in the scanning directions back and forth, it is possible that the conveyance rollers (i.e., the paper supply roller 10 and paper eject roller 12 on the side of the head 4 in the paper conveyance path in the drawing) that convey the sheet 8 may come into contact with the ink before the ink is dry, resulting in smudged images. Therefore, a certain length of latency is required before the sheet 8 is moved, and therefore it is difficult to increase the printing speed.

### SUMMARY OF THE INVENTION

An object of the present invention is accordingly to reduce the size of the apparatus and to provide an inkjet printer that can perform printing at a relatively high speed through the use of a head having nozzles aligned perpendicular to the sheet conveyance path.

To achieve at least one of the above mentioned objects, an ink jet printer reflecting one aspect of the present invention comprises:

an ink jet head having a first array of a plurality of nozzles from which ink drops are discharged, said nozzles being aligned at a prescribed pitch;

a scanning unit for scanning said ink jet head in a first direction so that the ink drops are discharged within a predetermined extent with respect to the first direction; and

a transporter for reciprocally transporting a recording medium in a second direction orthogonal to the first direction, said transporter being brought into contacting with a surface of the recording medium on which the ink drops are to be adhered, i.e., a recording surface, only at a position that is an outside of the predetermined extent with respect to the first direction.

In this ink jet printer, a part of intended image can be obtained by discharging ink drops from the nozzles with moving the recording medium in the second direction by transporter and with fixing the ink jet head at a position with respect to the first direction. After that, the ink jet head is moved to and fixed at a different position with respect to the first direction by the scanning unit, and then, other part of the intended image is formed by discharging ink drops from the nozzles with moving the recording medium in the second direction by transporter. By repeating the above process, the entire of the intended image can be finally formed on the recording medium. Since the transporter is brought into contact with the recording surface of the recording medium only at the position outside of the predetermined extent, the recorded ink that have not been dry is prevented from contacting with the member of the transporter, e.g., a roller. Therefore, a low cost printer that is capable of high speed recording without image quality deterioration can be obtained.

The nozzles of the first array may be aligned on a line parallel to or substantially parallel to the first direction, or be staggeringly aligned along with a line parallel to or substantially parallel to the first direction. The ink jet head may further have a second array of a plurality of nozzles aligned on a line parallel to or substantially parallel to the first direction, or be staggeringly aligned along with a line parallel to or substantially parallel to the first direction. The first and second arrays may be provided for mutually different colors.

### BRIEF DESCRIPTION OF THE DRAWINGS

These and other objects, advantages and features of the invention will become apparent from the following description thereof taken in conjunction with the accompanying drawings in which:

FIGS. 1(a) through 1(c) are drawings showing a first embodiment of the inkjet printer pertaining to the present invention;

FIG. 2 is drawings schematically showing the process of image formation using the inkjet printer shown in FIGS. 1(a) through 1(c);

FIGS. 3(a) through 3(c) are drawings showing a second embodiment of the inkjet printer pertaining to the present invention;

FIGS. 4(a) and 4(b) are a drawing showing the recording area (the area in which images may be formed) when the inkjet printer shown in FIGS. 1(a) and 1(b) is used, and a drawing showing the recording area when the inkjet printer shown in FIGS. 3(a) and 3(b) is used, respectively;

FIGS. 5(a) through 5(c) are drawings showing a third embodiment of the inkjet printer pertaining to the present invention;

FIGS. 6(a) through 6(c) are drawings showing a fourth embodiment of the inkjet printer pertaining to the present invention;

FIG. 7 is a drawing showing the recording area when the inkjet printer shown in FIGS. 6(a) and 6(b) is used;

FIG. 8 is a side elevation showing a fifth embodiment of the inkjet printer pertaining to the present invention;

FIG. 9 comprises side elevations showing modifications of the inkjet printer shown in FIG. 8;

FIGS. 10(a) and 10(b) show other examples of the alignment of the nozzles of the inkjet head; and

FIGS. 11(a) and 11(b) are drawings showing one example of the inkjet printer that forms images by repeating the operation in which the sheet is moved in either scanning direction and the head is forwarded by a prescribed pitch in the head forwarding direction.

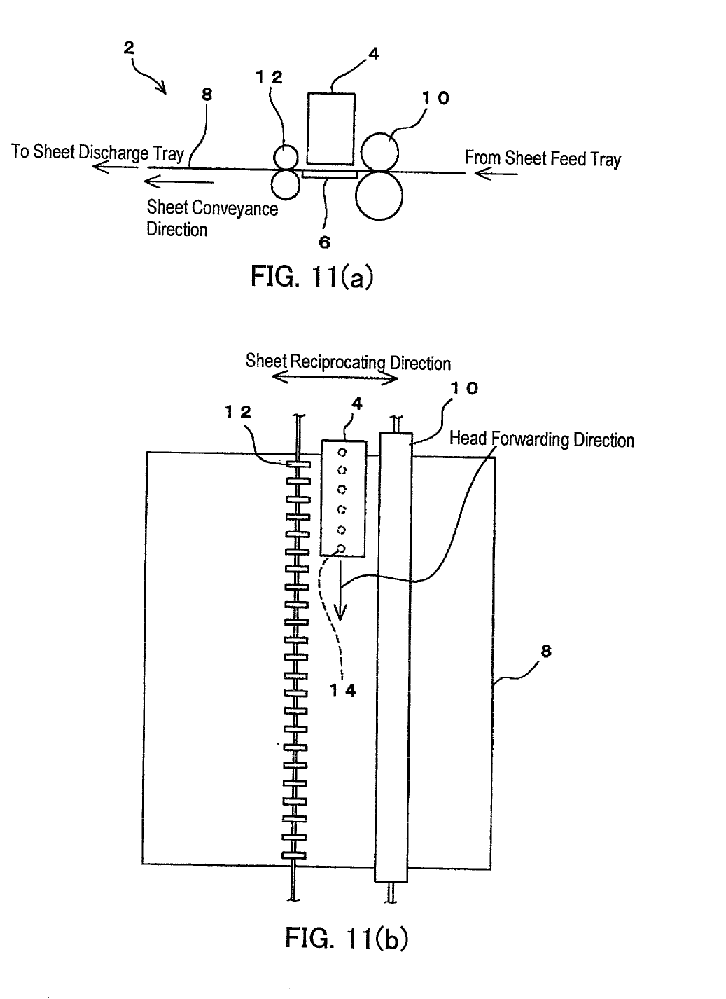

### DESCRIPTION OF THE PREFERRED EMBODIMENTS

The preferred embodiments of the present invention are explained below with reference to the accompanying drawings. In the explanation below, an array-type inkjet head is used that has four nozzle arrays for yellow (Y), cyan (C), magenta (M) and black (K), which extend along the entire width of the recording area along the head forwarding path. However, an inkjet printer that incorporates an inkjet head having at least one nozzle array or a serial-type inkjet head having nozzles that extend in an area smaller than the entire width of the recording area along the head forwarding path is also included in the scope of the present invention.

(First Embodiment)

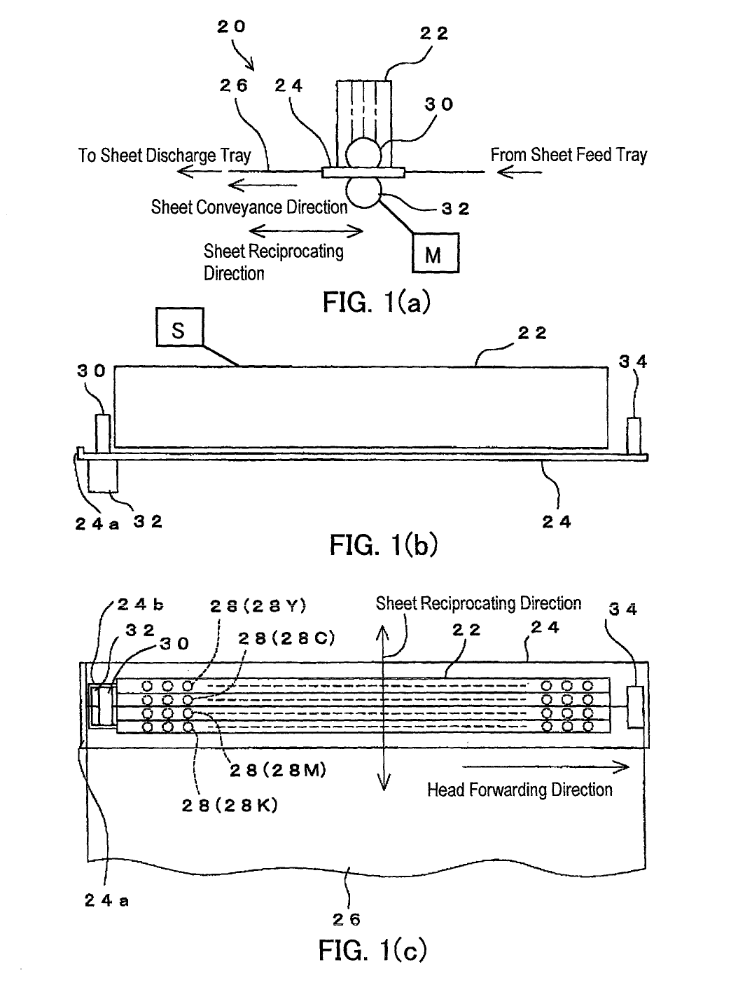

FIGS. 1(a) through 1(c) schematically show a first embodiment of the inkjet printer pertaining to the present invention. This printer 20 has an inkjet head 22 and a plate-like support member 24 that is located under the inkjet head 22. This support member 24 supports the sheet 26 such that the distance between the sheet 26 and the ink discharge surface is approximately maintained at constant. The head 22 is an array-type head having four nozzle arrays, and each nozzle array has nozzles 28 (28K, 28M, 28C, 28Y) that are aligned at a prescribed pitch (a 120 dpi printing density, or nozzle density, for example) along the head forwarding path perpendicular to the direction in which the sheet 26 is forwarded. In the example shown in the drawing, the nozzle arrays are located in the order of black, magenta, cyan and yellow along the sheet conveyance path.

The head 22 can move at a prescribed forwarding pitch in the head forwarding direction via the scanning mechanism S.

The support member 24 has at one end of its length, which extends along the length of the head 22 (or along the head forwarding path), a vertical wall 24a that extends along the sheet conveyance path, such that the sheet 26 comes into contact with this wall 24a, and moves on the support member 24 while being positioned at a certain position in the head forwarding path. The support member 24 has a pierced hole 24b, which extends along the head forwarding path, between the vertical wall 24a and the head 22. Conveyance rollers 30 and 32 are located above and below the support member 24, respectively, such that they are in contact with each other and sandwich the pierced hole 24b. To be more specific, the nipping areas (contact areas) of the conveyance rollers 30 and 32 are located on the same plane as the top surface of the support member 24. The lower conveyance roller 32 is connected to a motor M that can rotate forward and backward, while the upper conveyance roller 30 rotates as the lower conveyance roller 32 rotates. At the other end of the length of the support member 24, which extends along the length of the head 22 (or along the head forwarding path or the first path) is another conveyance roller 34, such that it is in contact with the top surface of the support member 24. This roller 34 rotates as the sheet 26 held between the nipping area formed by the support member 24 and the conveyance roller 34 moves. The conveyance roller 34 is also located such that the line connecting the nipping area formed by the support member 24 and the conveyance roller 34 and the nipping area formed by the conveyance rollers 30 and 32 is parallel to the head forwarding path.

Using this construction, the sheet 26 can move forward or backward in either sheet scanning direction (the second path), which is perpendicular to the head forwarding path, based on the forward or backward rotation of the motor connected to the conveyance roller 32, while being held at either edge thereof between the nipping areas of the conveyance rollers 30 and 32 and between the nipping areas of the conveyance roller 34 and the support member 24.

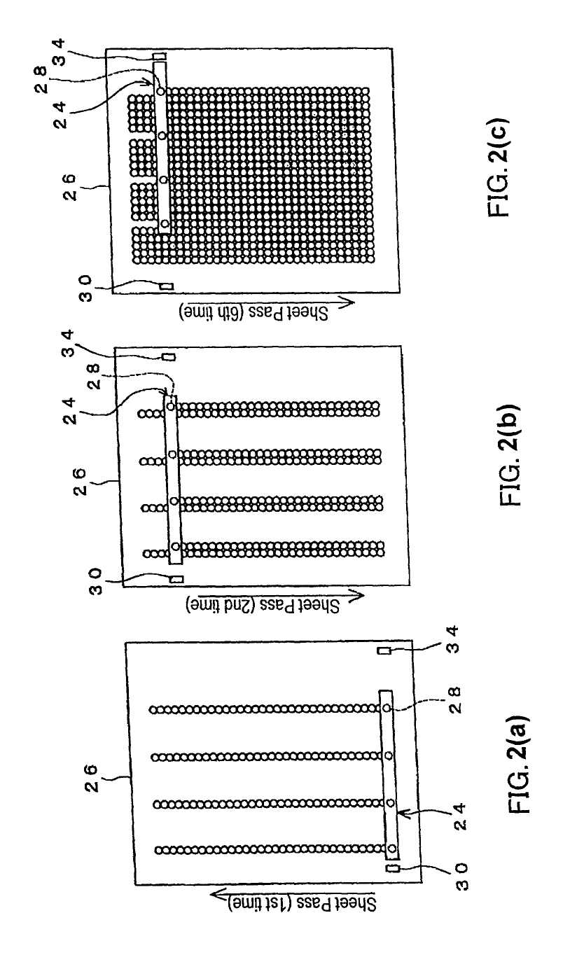

FIGS. 2(a) through 2(c) show a printing method in which a solid image having a 720 dpi resolution is printed using the head 22 having nozzles aligned at a 120 dpi pitch (in this drawing, the head has one nozzle array comprising four nozzles 28 for purposes of simplification, and each small circle represents an ink dot formed on the sheet 26). As shown in FIG. 1(c), the leading edge of the sheet 26 is made to come into contact with the nipping areas of the conveyance rollers 30 and 32 and the nipping areas of the conveyance roller 34 and the support member 24, the sheet 26 is moved upward in the drawing along the sheet scanning path, and one line of dots is printed by each nozzle 28 (FIG. 2(a)). The head 22 is then moved in the head forwarding direction in FIG. 1(c) by a distance equivalent to one pixel (approximately 35 μm). The sheet 26 is now moved downward along the sheet scanning path, and a second line is printed by each nozzle 28 (FIG. 2(b)). By repeating this operation in which the head 22 is moved by a distance equivalent to one pixel in the head forwarding direction and the sheet 26 is moved, a solid image is formed (FIG. 2(c)).

In this embodiment, because the conveyance members that move the sheet 26 forward and backward are located near the edges of the sheet 26, which are outside the recording area (the area in which images may be formed), the ink does not come into contact with the conveyance members, and high-quality images may be obtained even during high-speed printing.

(Second Embodiment)

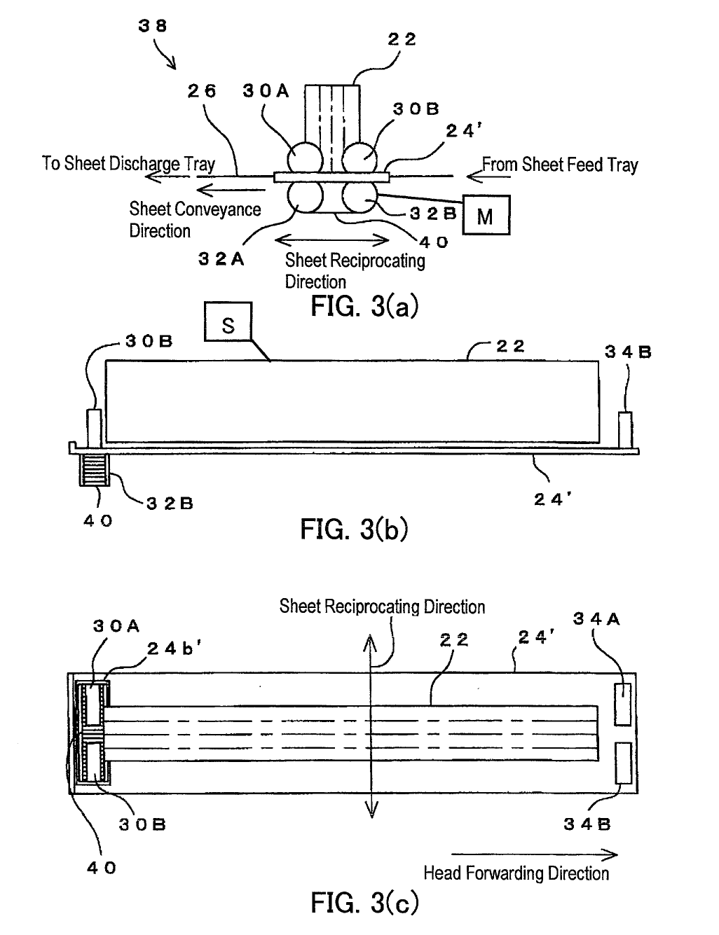

FIGS. 3(a) through 3(c) show a second embodiment of the inkjet printer pertaining to the present invention. In this printer 38, the conveyance mechanisms that move the sheet 26 forward and backward and that are located at either end of the head 22 along the head forwarding path comprise conveyance rollers 30A, 32A and 34A and conveyance rollers 30B, 32B and 34B, which are located downstream and upstream of the head 22, respectively, in terms of the direction in which the sheet 26 is conveyed. Either the lower conveyance roller 32A or 32B is connected to a motor (not shown in the drawings) that can rotate forward and backward. A belt 40 is wrapped around the lower conveyance rollers 32A and 32B, and the conveyance rollers 30A and 30B come into contact with the belt 40 via a pierced hole 24b′ formed on the support member 24′, so that the same sheet conveyance speed is maintained between the upstream and downstream sides of the head 22.

Using this construction, the sheet 26 may be moved forward or backward along the sheet scanning path based on the forward or backward rotation of the motor connected to the conveyance roller 32A or 32B while being held at either edge thereof between the nipping area formed by the conveyance rollers 30A, 30B and the belt 40 and the nipping area formed by the conveyance rollers 34A, 34B and the support member 24′.

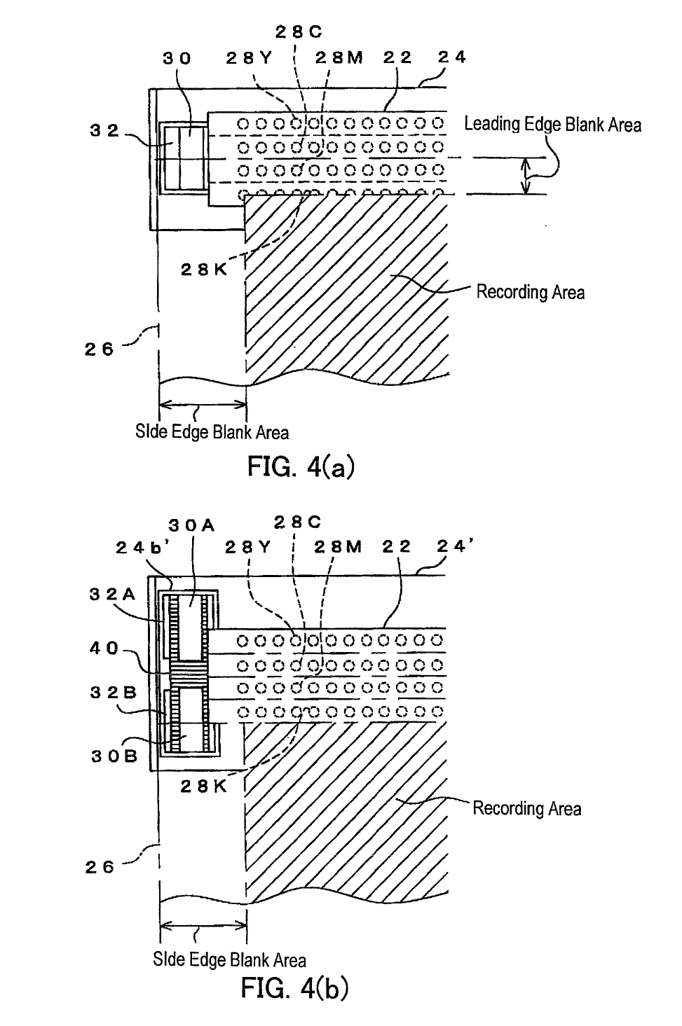

Incidentally, in the printer 20 shown in FIGS. 1(a) through 1(c), printing is performed after the leading edge of the sheet 26 comes into contact with the nipping area formed by the conveyance rollers 30 and 32 and the nipping area formed by the conveyance roller 34 and the support member 24. Therefore, as shown in FIG. 4(a), it is necessary to have a blank area in the leading edge area of the sheet 26 (similarly, a blank area needs to exist in the tail edge area as well). In contrast, in this embodiment, printing is performed after the leading edge of the sheet 26 comes into contact with the nipping area formed by the conveyance rollers 30B and 32B, and the nipping area formed by the conveyance roller 34B and the support member 24′, which are all upstream of the head 22. Therefore, as shown in FIG. 4(b), it is possible to keep the sheet 26 away from the area under the nozzles 28 while the leading edge of the sheet 26 is in contact with the above nipping areas. In this case, it is not necessary to have a blank area at the leading edge area of the sheet 26 (similarly, it is not necessary to have a blank area at the tailing edge area of the sheet 26 either).

(Third Embodiment)

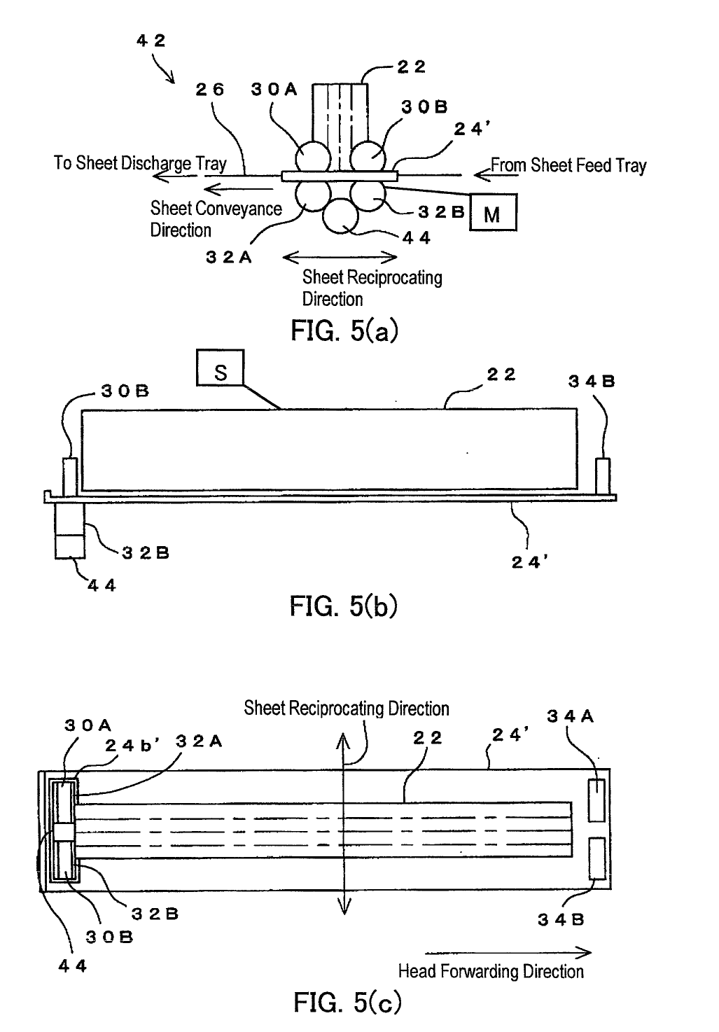

FIGS. 5(a) through 5(c) show a third-embodiment of the inkjet printer pertaining to the present invention. In this printer 42, the lower conveyance rollers 32A and 32B are driven and connected by one or more intermediate rollers 44, which are in contact with the outer surfaces of the conveyance rollers 32A and 32B (i.e., motive power is transmitted via the frictional force at the nipping area formed by the intermediate roller 44 and the conveyance roller 32A and at the nipping area formed by the intermediate roller 44 and the conveyance roller 32B), such that the same sheet conveyance speed is maintained between the upstream and downstream sides of the head 22.

(Fourth Embodiment)

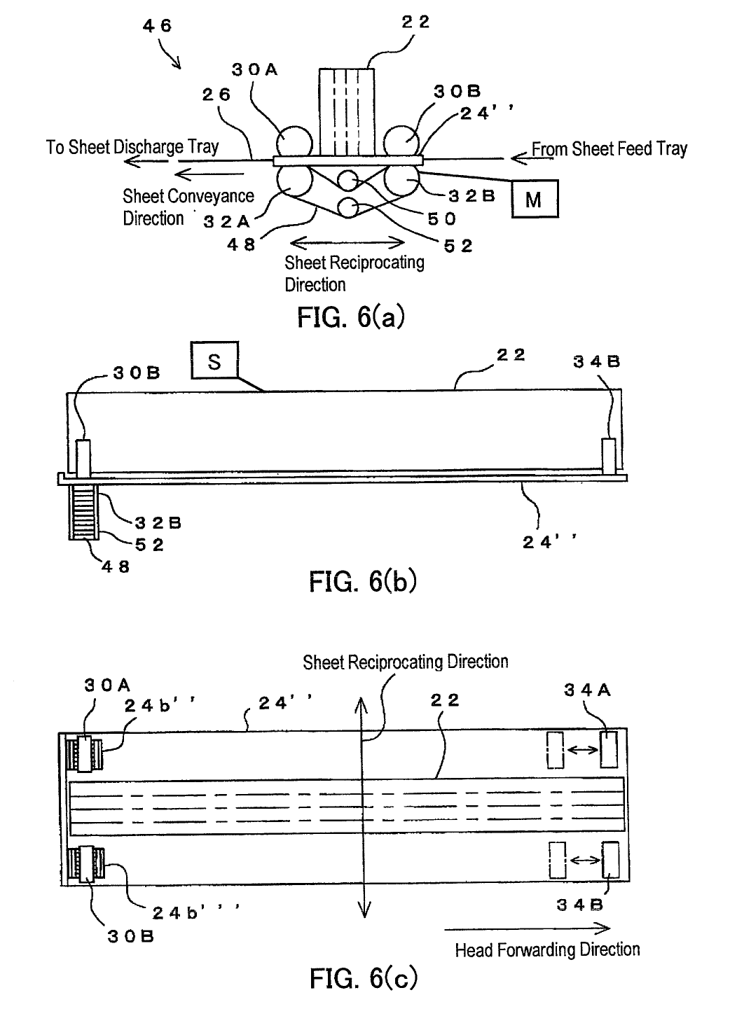

FIGS. 6(a) through 6(c) show a fourth embodiment of the inkjet printer pertaining to the present invention. In this printer 46, the conveyance rollers 30A, 32A and 34A and the conveyance rollers 30B, 32B and 34B, which are located downstream and upstream of the head 22 in terms of the sheet conveyance direction, respectively, are located such that the head 22 does not interfere with the conveyance rollers 30A, 30B, 34A and 34B when the head 22 moves in the head forwarding direction. To be more specific, a belt 48 is wrapped around the lower conveyance rollers 32A and 32B, and this belt 48 is bent downward via a pair of intermediate rollers 50 and 52, which are located essentially in the center between the lower conveyance rollers 32A and 32B, such that the belt 48 does not come into contact with the support member 24″. In addition, the belt 48 is in contact with the upper conveyance rollers 30A and 30B via pierced holes 24b″ and 24b′″ formed in the support member 24″.

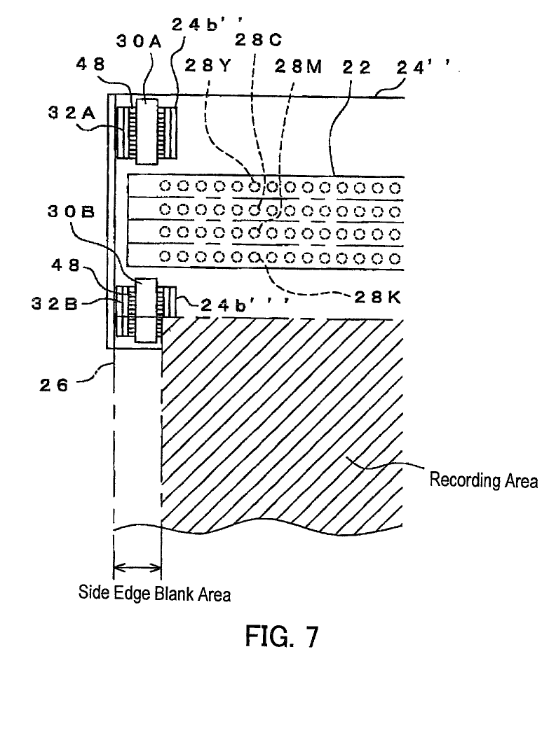

In this embodiment, because the conveyance rollers 30A, 30B, 34A and 34B are located such that they do not hinder the movement of the head 22 in the head forwarding direction, the side blank areas of the sheet 26 (the blank areas on the edges along the head forwarding path) may be made smaller than the side blank areas in the first embodiment shown in FIG. 4(a) or the side blank areas of the second embodiment shown in FIG. 4(b), as shown in FIG. 7.

In this embodiment, it is preferred that the construction be such that the conveyance rollers 34A and 34B, which function to press down the sheet, are movable laterally (in either direction parallel to the head forwarding path) as shown in FIG. 6(c), so that the printer 46 can handle sheets having a small width.

(Fifth Embodiment)

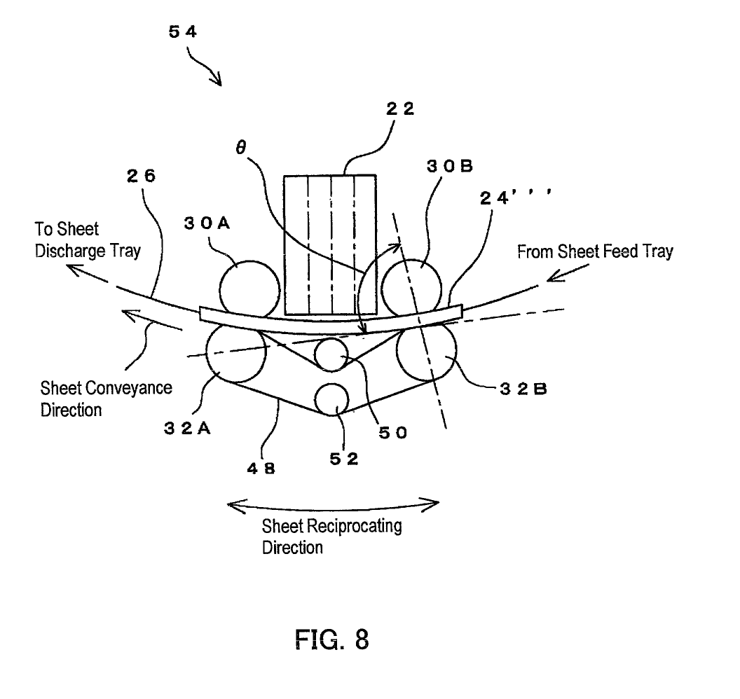

FIG. 8 shows a fifth embodiment of the inkjet printer pertaining to the present invention. In this printer 54, a convex member that curves away from the head 22 with a prescribed radius of curvature is used as the support member 24′″, and the upper conveyance rollers 30A and 30B are located such that the distance between the centers of the rollers 30A and 30B is smaller than the distance between the centers of the lower conveyance rollers 32A and 32B (i.e., as shown in the drawing, the angle θ between the line connecting the centers of the upper conveyance roller 30B and the lower conveyance roller 32B and the tangent line of the support member 24′″ at the crossing point between the above connecting line and the support member 24′″ is less than 90 degrees).

Using this construction, the area of the sheet that faces the head 22 may be placed in closer contact with the support member 24′″ than in the other embodiments described above, and as a result, the distance between the ink discharge surface of the head 22 and the sheet 26 may be maintained at an appropriate amount.

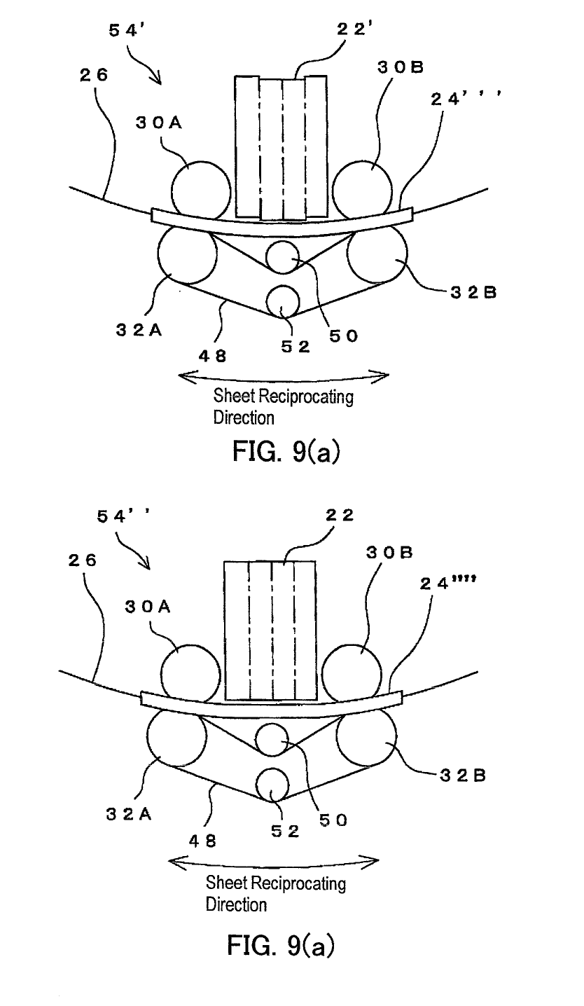

FIG. 9(a) and FIG. 9(b) show modifications of the printer shown in FIG. 8. In the printer 54′ of FIG. 9(a), the height of the nozzle is varied from one color to another along the sheet scanning path, such that the distance between the nozzle and the sheet 26 is essentially the same for all colors. In the printer 54″ of FIG. 9(b), the part of the support member 24″″ that faces the head 22 is made flat, such that the distance between the nozzle and the sheet 26 is essentially the same for all colors.

By making the distance between the support member and the nozzle of each color the same in this way, the variations in the positions of the dots of different color inks on the sheet may be reduced to the same degree.

The above explanation relates to some embodiments of the present invention, and the present invention may be implemented in various other forms. For example, the sheet conveyance path (the path that incorporates the path in which the sheet is supplied to the area that faces the head 22 and the path in which the sheet is ejected from said area) does not need to be parallel to the sheet scanning path, and these paths may be perpendicular to each other, for example.

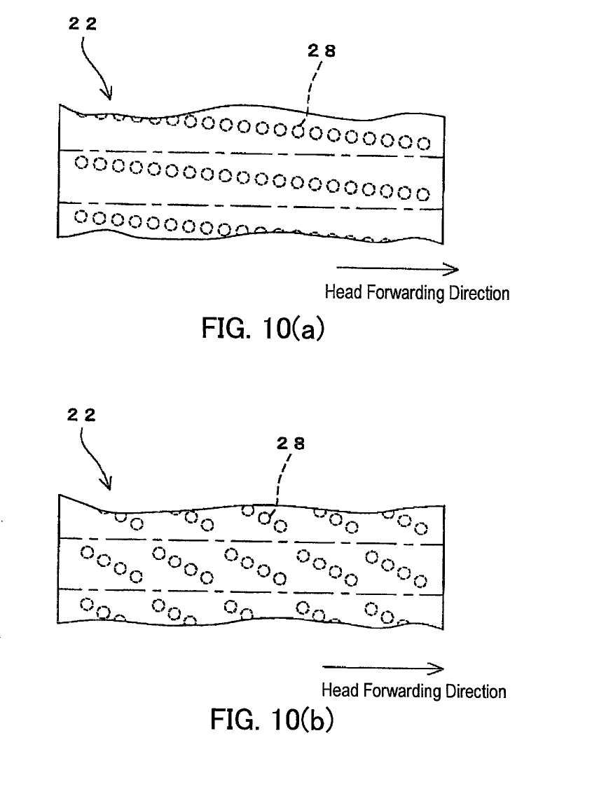

In addition, the nozzles 28 need not be aligned straight along the head forwarding path, as shown in FIG. 1(c). For example, as shown in FIG. 10(a), the nozzles 28 may be aligned in straight lines which are angled a prescribed amount relative to the head forwarding path, or as shown in FIG. 10(b), they may be divided into multiple blocks, with the nozzles 28 aligned straight in each block in a direction that has a prescribed angle to the head forwarding path.

The construction of the present invention in which a pair of conveyance members are located near either edge of the recording medium may be applied in an inkjet printer that has (i) an inkjet head that is located a prescribed distance from the recording medium and that has a multiple ink discharge outlets aligned along the sheet conveyance path, and (ii) a pair of conveyance members that (a) are in contact with either edge area of the recording medium in terms of the head scanning path, which is perpendicular to the sheet conveyance path and that (b) move the recording medium along the sheet conveyance path, wherein images are formed by repeating the operation in which the inkjet head is moved forward and backward as to the recording medium in the head scanning path and the recording medium is moved in the sheet conveyance direction by the pair of conveyance members.

Although the present invention has been fully described by way of examples with reference to the accompanying drawings, it is to be noted that various changes and modifications will be apparent to those skilled in the art. Therefore, unless otherwise such changes and modifications depart from the scope of the present invention, they should be construed as being included therein.

What is claimed is:

1. An ink jet printer comprising:
an ink jet head having a first array of a plurality of nozzles from which ink drops are discharged;
a scanning unit for scanning said ink jet head in a first direction so that the ink drops are discharged within a predetermined extent with respect to the first direction; and
a transporter for reciprocally transporting a recording medium in a second direction orthogonal to the first direction, said transporter comprising at least one member brought into contacting with a recording surface of the recording medium, said at least one member being provided at a position that is outside of the predetermined extent with respect to the first direction.

2. An inkjet printer as claimed in claim 1, wherein a part of intended image is printed on the recording medium by discharging ink drops from the nozzles with moving the recording medium in the second direction by transporter and with fixing the ink jet head at a first position with respect to the first direction.

3. An inkjet printer as claimed in claim 2, wherein the ink jet head is moved from the first position to at a second position that is different from the first position with respect to the first direction by the scanning unit, and other part of the intended image is formed by discharging ink drops from the nozzles with moving the recording medium in the second direction by transporter with fixing the ink jet head at the second position.

4. An inkjet printer as claimed in claim 1, the nozzles of the first array are aligned on a line parallel to or substantially parallel to the first direction.

5. An inkjet printer as claimed in claim 1, the nozzles of the first array are staggeringly aligned along with a line parallel to or substantially parallel to the first direction.

6. An inkjet printer as claimed in claim 1, wherein the nozzles of the first array are aligned at a prescribed pitch.

7. An inkjet printer as claimed in claim 1, further comprising:
a second array of a plurality of nozzles from which ink droplets are discharged.

8. An inkjet printer as claimed in claim 7, wherein the nozzles of the second array are aligned on a line parallel to or substantially parallel to the first direction.

9. An inkjet printer as claimed in claim 7, wherein the nozzles of the second array are staggeringly aligned along with a line parallel to or substantially parallel to the first direction.

10. An inkjet printer as claimed in claim 7, wherein the nozzles of the first array and the nozzles of the second array are provided for a first color ink and a second color ink, respectively.
